(19) United States
(12) Patent Application Publication
(10) Pub. No.: US 2013/0197759 A1
(43) Pub. Date: Aug. 1, 2013

(54) ENGINE RESTART CONTROL DEVICE

(71) Applicant: SUZUKI MOTOR CORPORATION, Shizuoka (JP)

(72) Inventors: Hiroshi URABE, Shizuoka (JP); Makoto KOIWAI, Shizuoka (JP)

(73) Assignee: SUZUKI MOTOR CORPORATION, Shizuoka (JP)

(21) Appl. No.: 13/751,436

(22) Filed: Jan. 28, 2013

(30) Foreign Application Priority Data
Jan. 31, 2012 (JP) 2012-017994

(51) Int. Cl. B60W 30/18; B60W 10/20; B60W 10/06

(52) U.S. Cl. CPC B60W 30/18054; B60W 10/06; B60W 10/20; B60W 2600/00
USPC 701/41

(57) ABSTRACT

There is provided an engine restart control device. A controller is configured to stop an engine which is adapted to generate a driving force for running a vehicle when a predetermined stop condition is met and configured to restart the engine when a predetermined restart condition is met after stopping the engine. A steering torque detector is configured to detect a steering torque of a steering handle which is adapted to be operated by a driver. A reaction force generator is configured to give a steering reaction force to the steering handle. The controller restarts the engine when the steering torque detected by the steering torque detector exceeds a predetermined threshold and control the reaction force generator to give the steering reaction force to the steering handle until the steering torque detected by the steering torque detector exceeds the predetermined threshold.

### CROSS-REFERENCE TO RELATED APPLICATIONS

This application claims the benefit of Japanese Patent Application No. 2012-017994, filed Jan. 31, 2012, in the Japanese Intellectual Property Office, the disclosures of which are incorporated herein by reference.

### BACKGROUND OF THE INVENTION

1. Field of the Invention

The present invention relates to an engine restart control device and, more particularly, to an engine restart control device which is capable of restarting an engine by a small rotation of a steering handle, even in a vehicle including a lightweight front axle or equipped with a narrow tire.

2. Description of the Related Art

There is a vehicle equipped with an engine restart control device which stops an engine when a stop condition such as stop during driving is met and restarts the engine when a restart condition such as accelerator pedal operation is met after the stop of the engine.

In a related art, an engine restart control device according to Patent Document 1 is configured to restart an engine when the change rate of steering torque or the change rate of steering angle of a steering handle in a stop state of an engine exceeds a predetermined threshold.

Further, in a related art, an engine restart control device according to Patent Document 2 is configured to restart an engine when it is determined that a stationary steering operation is carried out on the basis of a steering angle of a steering handle in a stop state of an engine.

Patent Document 1: Japanese Patent Application Publication No. 2005-271640A

Patent Document 2: Japanese Patent Application Publication No. 2000-345878A

In Patent Documents 1 and 2, an engine restart condition is determined on the basis of a steering condition such as a steering torque, a steering angle of a steering handle. There is a method for determining the steering condition of the steering handle on the basis of a steering torque which is detected by a steering torque sensor. However, according to this method, as illustrated in FIG. 4, unlike a vehicle such as a small car including a heavy front axle or equipped with a wide tire, in a vehicle such as a light car including a lightweight front axle or equipped with a narrow tire, rise of a steering torque to a steering angle is gradual and therefore a steering torque does not occur unless the steering handle is rotated (steered) in a large angle.

Therefore, in the control of an engine restart control device, when a threshold of a steering torque as an engine restart condition is set to the same value, irrespective of the weight of a front axle or the width of a tire, the following problem is caused. That is, on the contrary to a vehicle including a heavy front axle or equipped with a wide tire, in a vehicle including a lightweight front axle or equipped with a narrow tire, it is essential to increase the rotation amount (steering angle) of a steering handle required for generating a steering torque which exceeds a threshold meeting the engine restart condition.

As a result, in order to meet the engine restart condition in a vehicle including a lightweight front axle or equipped with a narrow tire, it is essential to rotate the steering handle in a large steering angle. Accordingly, there was a problem that it takes time to restart an engine and control failure is suspected. In addition, there was a problem that variation in a steering angle of a steering handle required for restarting an engine increases when the threshold of a restart steering torque of an engine is set small.

### SUMMARY OF THE INVENTION

It is therefore an object of the present invention to provide an engine restart control device which is capable of restarting an engine by a small steering angle, similarly to a vehicle including a heavy front axle or equipped with a wide tire, even in a vehicle including a lightweight front axle or equipped with a narrow tire.

In order to achieve the above object, according to an aspect of the embodiments of the present invention, there is provided an engine restart control device comprising: a controller configured to stop an engine which is adapted to generate a driving force for running a vehicle when a predetermined stop condition is met and configured to restart the engine when a predetermined restart condition is met after stopping the engine; a steering torque detector configured to detect a steering torque of a steering handle which is adapted to be operated by a driver; and a reaction force generator configured to give a steering reaction force to the steering handle, wherein the controller restarts the engine when the steering torque detected by the steering torque detector exceeds a predetermined threshold and control the reaction force generator to give the steering reaction force to the steering handle until the steering torque detected by the steering torque detector exceeds the predetermined threshold.

According to the present invention, since torque is generated in a direction opposite to a steering direction of the steering handle, it is possible to allow a steep rise of the steering torque to the steering angle of the steering handle, even in a vehicle including a lightweight front axle or equipped with a narrow tire. Accordingly, it is possible for a driver to restart an engine without rotating the steering handle in a large angle.

According to the present invention, since torque is generated in a direction opposite to a steering direction of the steering handle, it is possible to prevent difference in the steering angle of the steering handle required for restarting the engine in the rotation direction of left and right of the steering handle, even if there is a difference in the rise of the steering torque to the steering angle in accordance with the rotation direction of left and right of the steering handle.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

In the accompanying drawings:

FIG. 1 is a configuration view illustrating a system of an engine restart control device. (Embodiment)

FIG. 2 is a control flowchart of an engine restart control device. (Embodiment)

FIG. 3 is a view illustrating rise of a steering torque to a steering angle in accordance with the rotation direction of left and right of the steering handle. (Embodiment)

FIG. 4 is a view illustrating rise of a steering torque to a steering angle. (Related Art)

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, an embodiment of the present invention will be described by referring to the accompanying drawings.

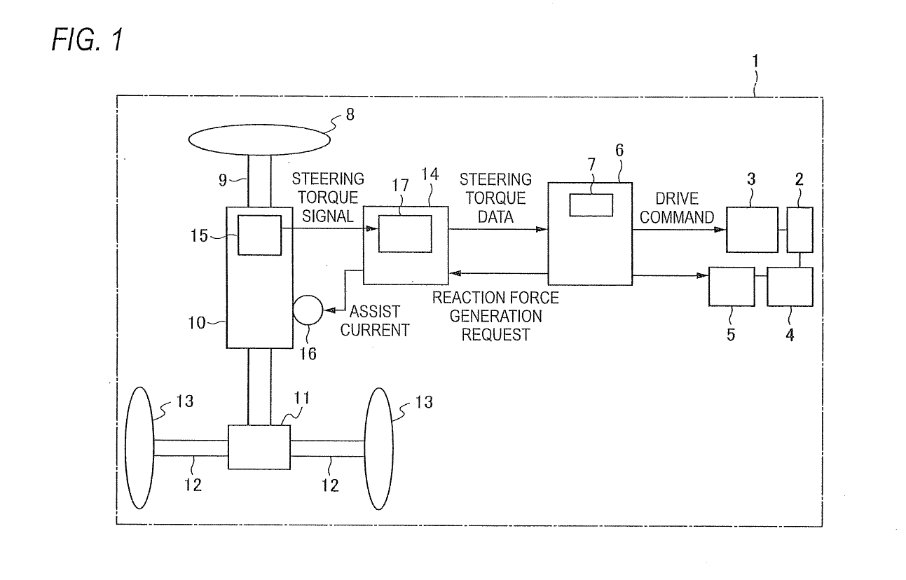

FIGS. 1 to 3 illustrate embodiments of the present invention. In FIG. 1, reference numeral 1 represents a vehicle, 2 represents an engine, 3 represents a starter, 4 represents a fuel injection valve and 5 represents an engine control means. The engine 2 is mounted on the vehicle 1. The engine 2 is supplied with fuel through the fuel injection valve 4 controlled by the engine control means 5 during cranking by the starter 3 so that the engine 2 is started. After the engine 2 is started, the starter 3 is stopped and the engine 2 continues to run by fuel supplied through the fuel injection valve 4. Consequently, the engine 2 generates a driving force for running the vehicle 1.

The vehicle 1 is equipped with an engine restart control device 6 which stops and restarts the engine 2. The engine restart control device 6 includes a control means 7. When a predetermined stop condition such as stop during driving is met, the control means 7 outputs a fuel stop command to the engine control means 5 to stop the engine 2 adapted to generate a driving force for running the vehicle 1. When a predetermined restart condition such as accelerator pedal operation is met after the stop of the engine 2, the control means 7 outputs a drive command to the starter 3 and outputs a fuel supply command to the engine control means 5 to restart the engine 2.

The vehicle 1 includes a steering shaft 9 coupled to a steering handle 8 which can be operated by a driver. The steering shaft 9 is pivotally supported on a steering column 10. Rotational movement of the steering shaft 9 is converted into linear movement by a steering gear box 11 and transmitted to a rack shaft 12. In this way, steered wheels 13 are steered.

The vehicle 1 is equipped with a steering control device 14 which reduces an operating force of the steering handle 8 by a driver. The steering control device 14 includes a steering torque detection means 15 and a motor 16 on the steering column 10. The steering torque detection means 15 detects a steering torque of the steering handle 8 which can be operated by a driver. The motor 16 generates a torque for reducing an operating force of a driver. The steering control device 14 includes a steering control means 17. The steering control means 17 determines a steering condition on the basis of a steering torque signal inputted from the steering torque detection means 15 and supplies an assist current to the motor 16 to reduce the operating force.

The engine restart control device 6 includes the steering torque detection means 15 detecting a steering torque of the steering handle 8 which can be operated by a driver and a reaction force generating means giving a steering reaction force to the steering handle 8. The reaction force generating means is the motor 16 which generates a torque for reducing an operating force of the steering handle 8 by a driver.

In the engine restart control device 6, a data of a steering torque detected by the steering torque detection means 15 is inputted to the control means 7 from the steering control means 17 of the steering control device 14. The control means 7 restarts the engine 2 when a driver operates the steering handle 8 after the stop of the engine 2 and the steering torque detected by the steering torque detection means 15 exceeds a threshold as a restart condition set in advance. At this time, the control means 7 outputs a reaction force generation request to the steering control device 14 and gives the steering reaction force to the steering handle 8 by the motor 16 which is the reaction force generating means until a driver operates the steering handle and the steering torque detected by the steering torque detection means 15 exceeds a threshold set in advance.

Next, an operation of the present embodiment will be described.

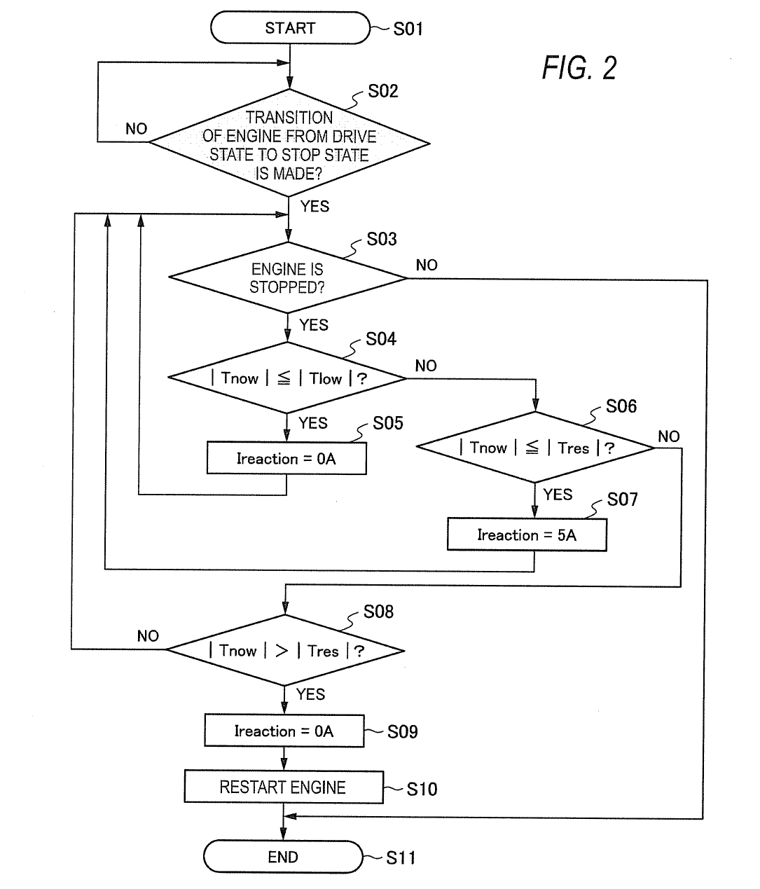

As illustrated in FIG. 2, when a control program is started (step S01), the engine restart control device 6 determines whether transition from a drive state to a stop state of the engine 2 is made or not (step S02).

If “NO” is determined in step S02, this step S02 is repeated. If “YES” is determined in step S02, it is determined whether the engine 2 is in a stop state or not (step S03).

If “NO” is determined in step S03, the program is ended (step S11). If “YES” is determined in step S03, it is determined whether the absolute value of a present steering torque Tnow is not more than the absolute value of a low threshold Tlow (for example, Tres*0.2) or not (step S04). Here, the low threshold Tlow is set smaller than a threshold Tres of a steering torque.

If “YES” is determined in step S04, the supply of reverse assist current to the motor 16 is stopped (Ireaction=0A) to let the motor 16 into a stop state (step S05) and then the whole process returns to step S03. If “NO” is determined in step S04, it is determined whether the absolute value of the present steering torque Tnow is not more than the absolute value of the threshold Tres of the steering torque or not (step S06).

If “YES” is determined in step S06, reverse assist current (for example, Ireaction=5A) is supplied to the motor 16 to let the motor 16 (step S07) into a drive state and then the whole process returns to step S03. In the drive state, the motor 16 gives a steering reaction force to the steering handle 8. The supplied reverse assist current is small so as not to give any discomfort during steering. Further, if “NO” is determined in step S06, it is determined whether the absolute value of the present steering torque Tnow exceeds the absolute value of the threshold Tres of the steering torque or not (step S08).

If “NO” is determined in step S08, the whole process returns to step S03. If “YES” is determined in step S08, the supply of reverse assist current to the motor 16 is stopped (Ireaction=0A) to let the motor 16 into the stop state (step S09). And, the engine 2 is restarted (step S10) and the program is ended (step S11).

As such, the engine restart control device 6 restarts the engine 2 when the steering torque Tnow detected by the steering torque detection means 15 exceeds the threshold Tres set in advance. The engine restart control device 6 gives a steering reaction force to the steering handle 8 by the motor 16 until the steering torque Tnow detected by the steering torque detection means 15 exceeds the threshold Tres set in advance.

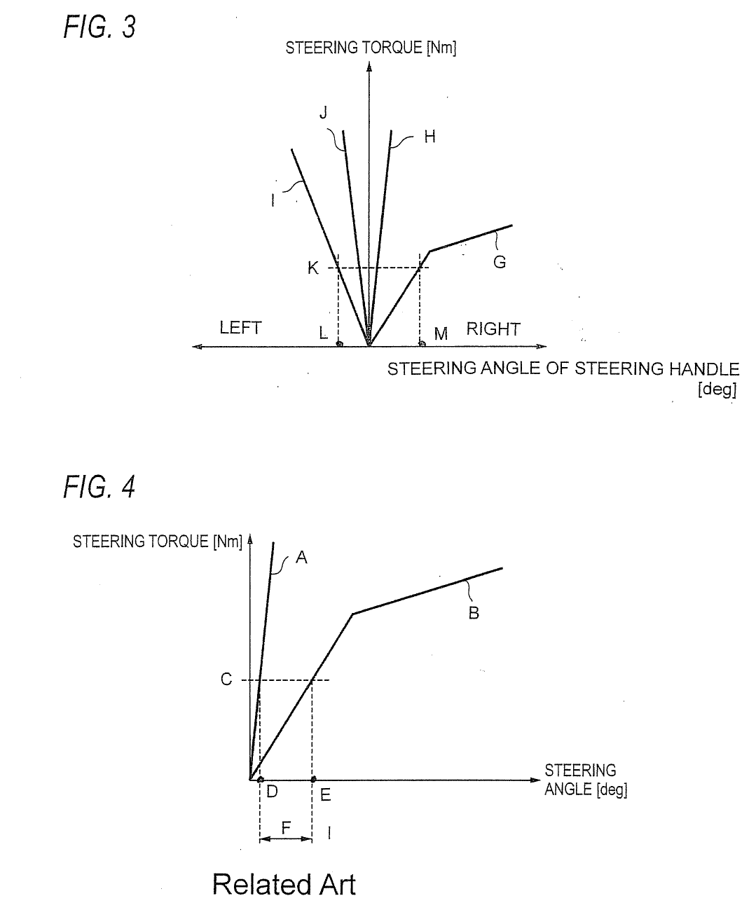

Thereby, according to the engine restart control device 6, since torque is generated in a direction opposite to a steering direction of the steering handle 8, it is possible to allow a steep rise of the steering torque to the steering angle of the steering handle 8, as illustrated in FIG. 3, even in a vehicle 1 including a lightweight front axle or equipped with a narrow tire.

Accordingly, it is possible for a driver to restart an engine 2 without rotating the steering handle 8 in a large angle.

Further, according to the engine restart control device 6, since torque is generated in a direction opposite to a steering direction of the steering handle 8, as illustrated in FIG. 3, it is possible to prevent difference in the steering angle of the steering handle required for restarting the engine in the rotation direction of left and right of the steering handle 8, even if there is a difference in the rise of the steering torque to the steering angle in accordance with the rotation direction of left and right of the steering handle 8.

Further, according to the engine restart control device 6, since the motor 16 of the steering control device 14 generates a torque to reduce an operating force of the steering handle 8 by a driver and a steering reaction force is generated using the motor 16 as a reaction force generating means, it is possible to generate a steering reaction force in the steering handle 8 without adding a new motor.

The engine restart control device of the present invention is capable of restarting an engine by a small steering angle, similarly to a vehicle including a heavy front axle or equipped with a wide tire, even in a vehicle including a lightweight front axle or equipped with a narrow tire. The present invention may be applied to a vehicle equipped with a steering control device.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An engine restart control device comprising:
a controller configured to stop an engine which is adapted to generate a driving force for running a vehicle when a predetermined stop condition is met and configured to restart the engine when a predetermined restart condition is met after stopping the engine;
a steering torque detector configured to detect a steering torque of a steering handle which is adapted to be operated by a driver; and
a reaction force generator configured to give a steering reaction force to the steering handle,
wherein the controller restarts the engine when the steering torque detected by the steering torque detector exceeds a predetermined threshold and control the reaction force generator to give the steering reaction force to the steering handle until the steering torque detected by the steering torque detector exceeds the predetermined threshold.

2. The engine restart control device according to claim 1, wherein the reaction force generator is a motor configured to generate a torque for reducing an operation force of the steering handle by the driver.
